(19) United States
(12) Patent Application Publication
(10) Pub. No.: US 2026/0237282 A1
(43) Pub. Date: Aug. 13, 2026

(54) Machine learning-based debris flow early warning method

(71) Applicants: Institute of Mountain Hazards and Environment, CAS, Chengdu (CN); Tsinghua University, Beijing (CN)

(72) Inventors: Shuai LI, Chengdu (CN); Yanling LIU, Chengdu (CN); Chaojun OUYANG, Chengdu (CN); Yifei CUI, Chengdu (CN); Yonggang GE, Chengdu (CN); Jiangang CHEN, Chengdu (CN); Xiaojun GUO, Chengdu (CN); Hongling TIAN, Chengdu (CN); Tianpei WU, Chengdu (CN); Yunsheng WANG, Chengdu (CN)

(73) Assignees: Institute of Mountain Hazards and Environment, CAS, Chengdu (CN); Tsinghua University, Beijing (CN)

(21) Appl. No.: 19/344,568

(22) Filed: Sep. 30, 2025

(30) Foreign Application Priority Data
Feb. 13, 2025 (CN) 202510160490X

(51) Int. Cl. G08B 21/10; G06N 3/0442; G08B 21/18; G08B 31/00

(52) U.S. Cl. CPC G08B 21/10; G06N 3/0442; G08B 21/182; G08B 31/00

(57) ABSTRACT

A machine learning-based debris flow early warning method includes: acquiring a debris flow-induced ground vibration signal; identifying the debris flow-induced ground vibration signal through a patch attention mechanism-based debris flow-induced ground vibration signal identification model, and deriving a debris flow-induced ground vibration signal identification result; and performing debris flow early warning according to a set alarm threshold based on the debris flow-induced ground vibration signal identification result. The method enables precise early warnings for multiple debris flows occurring within short intervals, demonstrating its potential in practical applications.

### CROSS REFERENCE TO THE RELATED APPLICATIONS

This application is based upon and claims priority to Chinese Patent Application No. 202510160490.X, filed on Feb. 13, 2025, the entire contents of which are incorporated herein by reference.

### TECHNICAL FIELD

The present disclosure relates to the field of geological hazard identification, and in particular to a machine learning-based debris flow early warning method.

### BACKGROUND

Debris flow is a highly destructive surface hazard, commonly occurring in mountainous or hilly areas. It primarily includes water, soil, rocks, and other debris, exhibiting high fluidity and impact force. Due to the high uncertainty and suddenness of debris flow, debris flow early warning is particularly crucial.

Among major traditional debris flow warning methods, those triggering early warnings by monitoring rainfall in real-time feature low cost and simple operation but rely solely on rainfall data, making them hard to achieve comprehensive risk assessment. Those simulating rainfall-surface water relationships through hydrological models depend on data quality and suffer from limited accuracy due to insufficient data. Those establishing early warning models by setting critical rainfall thresholds based on historical data and incorporating multifaceted data enable precise early warnings but are prone to deviations due to environmental changes, thereby compromising their reliability. Those based on comprehensive assessment of geological environment factors such as terrain, soil, and vegetation can obtain comprehensive debris flow susceptibility information but are time-consuming, costly, and hard to respond rapidly.

In recent years, machine learning methods have gradually been applied to debris flow early warning but still face numerous challenges: 1) traditional models cannot directly process raw waveforms of ground vibration signals, and rely on manual feature extraction, which may introduce redundant or insufficient features, leading to unreasonable inductive bias; and 2) convolutional neural networks (CNNs) require multiple stacked layers for dimension reduction, easily causing overfitting. In view of this, the present disclosure proposes a transformer-based improved model, patch Fourier transformer (PFT). PFT can effectively perceive energy changes in the time-frequency map through a patch attention mechanism and exhibit attention weights highly consistent with their spatiotemporal distribution. Tests using ground vibration data from more than ten debris flow events occurring at Illgraben in 2020 demonstrated early warning times ranging from tens of minutes to several hours with zero false alarms. The results highlight the substantial potential and advantages of PFT in debris flow early warning tasks.

### SUMMARY

In order to overcome the deficiencies in the prior art, the present disclosure provides a machine learning-based debris flow early warning method.

To achieve the above objective, the present disclosure adopts the following technical solution:

A machine learning-based debris flow early warning method includes the following steps:
S1: acquiring a debris flow-induced ground vibration signal, and constructing a patch attention mechanism-based debris flow-induced ground vibration signal identification model;
S2: extracting a temporal feature of the debris flow-induced ground vibration signal through the constructed patch attention mechanism-based debris flow-induced ground vibration signal identification model, and embedding positional encodings at different positions;
S3: calculating an attention weight through a multi-head attention mechanism, and deriving a debris flow-induced ground vibration signal identification result through a fully connected layer; and
S4: performing debris flow early warning according to a set alarm threshold based on the debris flow-induced ground vibration signal identification result.

Furthermore, the step S2 specifically includes the following steps:
S21: performing instance normalization on the debris flow-induced ground vibration signal through the patch attention mechanism-based debris flow-induced ground vibration signal identification model;
S22: segmenting the debris flow-induced ground vibration signal through an overlapping sliding window, and performing Fourier transform on each segmented patch to obtain a patch sequence; and
S23: extracting a temporal feature of patches in the patch sequence obtained after Fourier transform through a long short-term memory (LSTM) model, and embedding positional encodings of the patches at corresponding positions.

Furthermore, the S23 specifically includes the following steps:
S231: segmenting the patch sequence obtained after Fourier transform into a patch sequence with a reduced dimension through the overlapping sliding window;
S232: allowing each patch in the patch sequence with the reduced dimension to pass through the LSTM model to extract a temporal feature of the corresponding patches, such that an original patch sequence is transformed into new patch sequences with the reduced dimension and an unchanged patch count, and the LSTM model shares weights across all the new patch sequences; and
S233: embedding positional information of the new patch sequences into the constructed debris flow-induced ground vibration signal identification model through the positional encodings.

Furthermore, specifically, in the step S233, the embedding is performed by:

$$P {E}_{( p o s , 2 i )} = sin ( \frac{p o s}{1 {0000}^{\frac{2 i}{{d}_{m o d e l}}}} )$$

$${PE}_{( p o s , 2 i + 1 )} = cos ( \frac{p o s}{1 {0000}^{\frac{2 i}{{d}_{m o d e l}}}} )$$

where PE denotes embedding for a dimension corresponding to a current position and a position vector; pos denotes the current position; i denotes a dimension index in the position vector; and d_{model} denotes a dimension of an input vector.

Furthermore, in the step S233, a patch embedded with the positional encoding is expressed as:

$${\tilde{x}}_{i}^{d} = {W}_{P} ( {\tilde{x}}_{i} ) + {W}_{p o s}$$

where

$${\tilde{x}}_{i}^{d}$$

denotes the patch embedded with the positional encoding; Wₚₒₛ denotes the positional encoding; and \tilde{x}ᵢ denotes a patch in the new patch sequence.

Furthermore, the step S3 specifically includes the following steps:
S31: taking a patch embedded with the positional encoding as an encoder input;
S32: transforming the encoder input into a query matrix, a key matrix, and a value matrix through the multi-head attention mechanism;
S33: calculating an attention based on the query matrix, the key matrix, and the value matrix;
S34: concatenating outputs of all heads, and mapping a concatenated result to a set dimension of the constructed debris flow-induced ground vibration signal identification model through a linear layer; and
S35: designing a loss function to measure a difference between a predicted probability and a true probability token, and outputting the debris flow-induced ground vibration signal identification result.

Furthermore, in the step S32, the query matrix, the key matrix, and the value matrix are respectively expressed as:

$${Q}_{i}^{h} = {( {\tilde{x}}_{i}^{d} )}^{T} {W}_{Q}^{h}$$

$${K}_{i}^{h} = {( {\tilde{x}}_{i}^{d} )}^{T} {W}_{K}^{h}$$

$${V}_{i}^{h} = {( {\tilde{x}}_{i}^{d} )}^{T} {W}_{V}^{h}$$

where

$${Q}_{i}^{h} , {K}_{i}^{h} , {V}_{i}^{h}$$

denote the query matrix, the key matrix, and the value matrix of an h-th head, respectively; and

$${W}_{Q}^{h} , {W}_{K}^{h} , {W}_{V}^{h}$$

denote linear transformation matrices corresponding to the query matrix, the key matrix, and the value matrix of the h-th head, respectively.

Furthermore, in the step S34, the concatenated result is mapped to the set dimension of the constructed debris flow-induced ground vibration signal identification model through the linear layer specifically by:

$$MultiHead ( {Q}_{i} , {K}_{i} , {V}_{i} ) = Concat ( {head}_{1} , {head}_{2} … {head}_{H} ) {W}_{O}$$

where Qᵢ, Kᵢ, Vᵢ denote the query matrix, the key matrix, and the value matrix, respectively; head_{H} denotes an output of each head, with subscripted H denoting a head index; and W_{O} denotes a weight matrix of the linear layer.

Furthermore, in the step S35, the loss function is expressed as:

$$B C E ( y , \hat{y} ) = - \frac{1}{N} {\sum }_{i}^{N} [ {y}_{i} log ( {\hat{y}}_{i} ) + ( 1 - {y}_{i} ) log ( 1 - {\hat{y}}_{i} ) ]$$

where N denotes a sample size; yᵢ denotes a true token of an i-th sample; ŷᵢ denotes a predicted probability of the i-th sample; and BCE denotes a binary cross-entropy loss function.

The present disclosure has the following beneficial effects:

The present disclosure is used to identify debris flows from continuous ground vibration signals, and the PFT attention weight distribution exhibits high similarity with the time-frequency map. The model of the present disclosure demonstrates high accuracy in debris flow waveform identification, and achieves zero false alarms and zero missed detections while providing early warning times ranging from tens of minutes to several hours. In addition, the model is capable of enabling precise early warnings for multiple debris flows occurring within short intervals, demonstrating its potential in practical applications.

### BRIEF DESCRIPTION OF THE DRAWINGS

FIG. 1 is a schematic diagram of a machine learning-based debris flow early warning method in the present disclosure;

FIG. 2 is a schematic diagram of model performance under different wavelengths in an embodiment of the present disclosure;

FIG. 3A is a schematic diagram of early warning times provided by different models for different debris flows in an embodiment of the present disclosure;

FIG. 3B is a schematic diagram of F1 and threat score (TS) results of a PFT model at station ILL18 in an embodiment of the present disclosure;

FIG. 3C is a schematic diagram of F1 and TS results of the PFT model at station ILL13 in an embodiment of the present disclosure; and

FIG. 3D is a schematic diagram of F1 and TS results of the PFT model at station ILL12 in an embodiment of the present disclosure.

### DETAILED DESCRIPTION OF THE EMBODIMENTS

The specific embodiment of the present disclosure will be described below so that those skilled in the art can understand the present disclosure, but it should be clear that the present disclosure is not limited to the scope of the specific embodiment. For those of ordinary skill in the art, as long as various changes fall within the spirit and scope of the present disclosure defined and determined by the appended claims, these changes are apparent, and all inventions and creations using the concept of the present disclosure are protected.

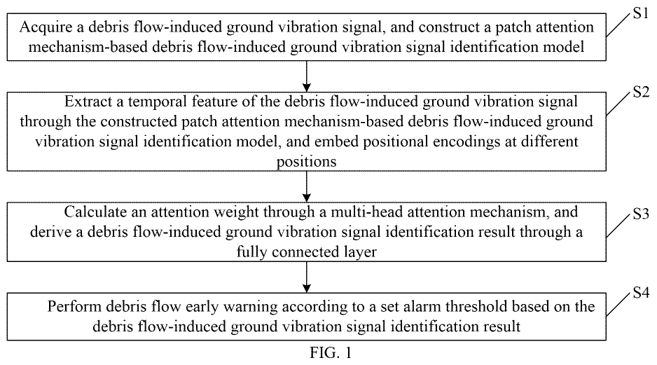

As shown in FIG. 1, a machine learning-based debris flow early warning method includes the following steps.
S1. A debris flow-induced ground vibration signal is acquired, and a patch attention mechanism-based debris flow-induced ground vibration signal identification model is constructed.

Due to the imbalance between debris flow (positive) and noise (negative) samples in the entire dataset, noise samples from 2017 to 2019 are randomly sampled to achieve a 1:1 positive-to-negative sample ratio, ensuring that the model can adequately learn waveform features of debris flows. The dataset is divided into a training set, a validation set, and a test set with proportions of 80%, 10%, and 10% respectively. The training set is primarily used for the model to learn high-level feature representations of waveform data. The validation set is used to prevent model overfitting and to timely save the optimal model state through an early stopping strategy. The test set is used for final model performance evaluation to ensure unbiased results. Data from 2020 is used to assess the model's continuous identification and early warning performance for ground vibration signals during final actual operation.

Supervised learning is adopted in this study. The start and end times of each debris flow event in the training set are defined by timestamps. Within these time intervals, tokens of relevant samples are set to 1. Considering the uncertainty of manual tokening and specific features of debris flow events, tokens before and after the commencement of a debris flow event are set to increase linearly from 0 to 1, and tokens before and after the termination of a debris flow event are set to decrease linearly from 1 to 0, blurring the exact start and end times to enhance the model's ability to identify event boundaries.

To obtain sufficiently comprehensive contextual information, three-component waveforms are segmented into 5-min-long waveforms with an overlap rate of 80%, meaning each segmentation stride is 1 min.
S2. A temporal feature of the debris flow-induced ground vibration signal is extracted through the constructed patch attention mechanism-based debris flow-induced ground vibration signal identification model, and positional encodings at different positions are embedded.

The encoder-only transformer architecture is primarily used for tasks that do not require sequence generation, such as text classification, entity identification, or sentence embedding generation. In this architecture, only the encoder part of the transformer is included, with each encoder layer consisting of a self-attention mechanism and a feedforward network. This architecture captures global dependencies among elements in the input sequence to generate high-quality feature representations, effectively supporting downstream classification or other tasks.

The problem is defined as follows. Given a three-component data sample, [symbol] ∈ [symbol] ^{3×L}, where L denotes the length of the waveform. The model of the present disclosure is denoted as [symbol] , [symbol] = [symbol] ( [symbol] )∈ [symbol] ^{1×C}, where C denotes a classification probability for each min of the waveform. The model of the present disclosure employs a transformer encoder as the core architecture.

In this embodiment, the step specifically includes the following steps.
S21. Instance normalization is performed on the debris flow-induced ground vibration signal through the patch attention mechanism-based debris flow-induced ground vibration signal identification model.

Instance normalization independently normalizes data for each channel in each sample to adjust data scale and distribution, making the model training process more stable and facilitating rapid convergence in the early stages of training.

$$Norm\_x = γ ( \frac{x ( t ) - μ}{σ + ε} ) + β$$

where x(t) denotes an original value at time point t; μ and σ denote a mean and a standard deviation of the waveform, respectively; and γ and β denote learnable scaling and shifting parameters, respectively.
S22. The debris flow-induced ground vibration signal is segmented through an overlapping sliding window, and Fourier transform is performed on each segmented patch to obtain a patch sequence.

Data xᵢ∈ [symbol] ^{1×L} (i=1, 2, 3) of each channel in the input sample is divided into overlapping patches, with a length of each patch denoted as [symbol] and a stride of each patch denoted as [symbol] . In this process, xᵢ becomes

$${x}_{i}^{p} ∈ {ℝ}^{𝒫 \times N} ,$$

where N is the number of patches and

$$N = [ \frac{( L - P )}{S} ] + 2 .$$

In time-series models, the Fourier transform can effectively capture frequency features in data, helping models better identify and understand patterns hidden across temporal dimensions. Meanwhile, the Fourier transform can efficiently separate noise, particularly high-frequency noise, in the frequency domain, thereby enhancing signal quality. Additionally, the Fourier transform can convert complex time-series data from the time domain into simple frequency components in the frequency domain, simplifying data processing and reducing model complexity.
S23. A temporal feature of patches in the patch sequence obtained after Fourier transform is extracted through a long short-term memory (LSTM) model, and positional encodings of the patches at corresponding positions are embedded.

Specifically:
S231. The patch sequence obtained after Fourier transform is transformed into a patch sequence with a reduced dimension through the overlapping sliding window.
S232. Each patch in the patch sequence with the reduced dimension is allowed to pass through the LSTM model to extract a temporal feature of the corresponding patches, such that an original patch sequence is transformed into new patch sequences with the reduced dimension and an unchanged patch count, and the LSTM model shares weights across all the new patch sequences.

When the sequence length increases, the dimension of each patch in the sequence correspondingly increases. The LSTM is utilized to capture dependencies within the patch sequence and retain the critical information during dimension reduction. Each patch:

$${x}_{i}^{p} ∈ {ℝ}^{𝒫}$$

is transformed into smaller patches:

$${x}_{i , j}^{p} ∈ {ℝ}^{\overline{𝒫}} ,$$

where j=1, 2 . . . K denotes the index of the smaller patches, [symbol] denotes the dimension of each smaller patch, [symbol] = [symbol] ×K. Each patch becomes

$${\tilde{x}}_{i}^{p} = LST M ( {x}_{i}^{p} ) ∈ {ℝ}^{𝓅}$$

after being processed through the LSTM, and finally the original sequence becomes \tilde{x}ᵢ∈ [symbol] , with the LSTM sharing weights across all the patches.
S233. Positional information of the new patch sequences are embedded into the constructed debris flow-induced ground vibration signal identification model through the positional encodings.

In the attention mechanism of transformer, the process of calculating attention weights is unordered and cannot directly capture sequential relationships between patches in the waveform. Sequential order between patches is particularly important for waveform identification. Therefore, positional information of patches in the waveform is explicitly injected into the model through positional encoding. The embedding method of the present disclosure is as follows:

$$P {E}_{( p o s , 2 i )} = sin ( \frac{p o s}{1 {0000}^{\frac{2 i}{{d}_{m o d e l}}}} )$$

$$P {E}_{( p o s , 2 i + 1 )} = cos ( \frac{p o s}{1 {0000}^{\frac{2 i}{{d}_{m o d e l}}}} )$$

where pos denotes a current position (an index in the sequence); i denotes a dimension index in the position vector; and d_{model} denotes a dimension of an input vector.
S3. An attention weight is calculated through a multi-head attention mechanism, and a debris flow-induced ground vibration signal identification result is derived through a fully connected layer.

In this embodiment, the step specifically includes the following steps.
S31. A patch embedded with the positional encoding is used as an encoder input.

The encoder-only transformer architecture is primarily used for tasks that do not require sequence generation, such as text classification, entity identification, or sentence embedding generation. In this architecture, only the encoder part of the transformer is included, with each encoder layer consisting of a self-attention mechanism and a feedforward network. This architecture captures global dependencies among elements in the input sequence to generate high-quality feature representations, effectively supporting downstream classification or other tasks.
S32. The encoder input is transformed into a query matrix, a key matrix, and a value matrix through the multi-head attention mechanism.

For each token in the input, the query, key and value vectors are calculated. These vectors are acquired through linear transformations (weight matrices), with the matrix size being N×d. Therefore, the computational complexity for the query, key, and value is O(N·d²).

Each query calculates dot products with all other keys, resulting in an attention score matrix of N×N. Thus, the complexity of dot products is O(N²).

Softmax is applied for each query to obtain weights, with an operation complexity of O(N²).

The output corresponding to each query is the weighted sum of all values. The complexity of this weighted summation is O(N²), since the output at each position requires weighted summation over N values.

Therefore, the total computational complexity for a single self-attention operation is: O(N·d²).
S33. An attention is calculated based on the query matrix, the key matrix, and the value matrix.

Each transformer layer additionally includes a feedforward network, typically composed of two linear transformations and an activation function (such as rectified linear unit (ReLU)). Assuming the hidden layer dimension per layer is d_{ff} (usually d_{ff}>>d), the computational process of the feedforward network includes:
First linear transformation: from dimension d to d_{ff}, with a computational complexity of O(N·d·d_{ff}).
Activation function: assuming constant complexity O(1) for the activation function, the complexity for this operation is O(N·d_{ff}).
Second linear transformation: from d_{ff} back to d, with a computational complexity of O(N·d_{ff}·d).

Thus, the total complexity of the feedforward network is: O(N·d_{ff}·d).

Space complexity primarily consists of the following parts:
Input and output storage: Storage is required for inputs and outputs of each token, so the space complexity for inputs and outputs is O(N·d).
Self-attention weight matrix: Self-attention requires storing an N×N attention score matrix, with a space complexity of O(N²).
Parameters of the feedforward network: The feedforward network has two weight matrices for linear transformations, sized d×d_{ff} and d_{ff}×d, respectively, resulting in a space complexity of O(d_{ff}·d).

Therefore, the space complexity per layer is: O(N²+N·d+d_{ff}·d).

L denotes the number of transformer layers, N denotes the length of the input sequence, d denotes the hidden layer dimension, and d_{ff} denotes the hidden layer dimension of the feedforward network.

When a one-dimensional sequence is segmented into patches with stride s, the segmentation method differs from the non-stride case. The stride s denotes the distance between two consecutive patches, typically smaller than the patch length L_{patch} (also termed “overlap”). This approach resembles a sliding window operation.

To calculate the number of segmented patches, an equation is derived based on the stride and the patch length. The sequence length N is divided into multiple patches, with start positions of each patch at 0, s, 2s, . . . , until the last patch's start position does not exceed N−L_{patch}. Thus, the number of segmented patches is:

$${N}_{patch} = ( \frac{N - {L}_{patch}}{s} ) + 1 .$$

With the stride s considered, the time complexity of self-attention depends on the new sequence length N_{patch} and the dimension d of each patch. The time complexity of self-attention per layer remains O(N_{patch}²·d), while the space complexity is O(N_{patch}²+N_{patch}·d).
S34. Outputs of all heads are concatenated, and a concatenated result is mapped to a set dimension of the constructed debris flow-induced ground vibration signal identification model through a linear layer.

After the positional encodings of the patches at different positions are computed, \tilde{x}ᵢ∈ [symbol] is first projected into the model's feature space d_{model} via a linear layer with the positional encodings embedded,

$${\tilde{x}}_{i}^{d} = {W}_{P} ( {\tilde{x}}_{i} ) + {W}_{p o s} ,$$

W_{P}∈ [symbol] , Wₚₒₛ∈ [symbol] ^{D×N}. Then,

$${\tilde{x}}_{i}^{d}$$

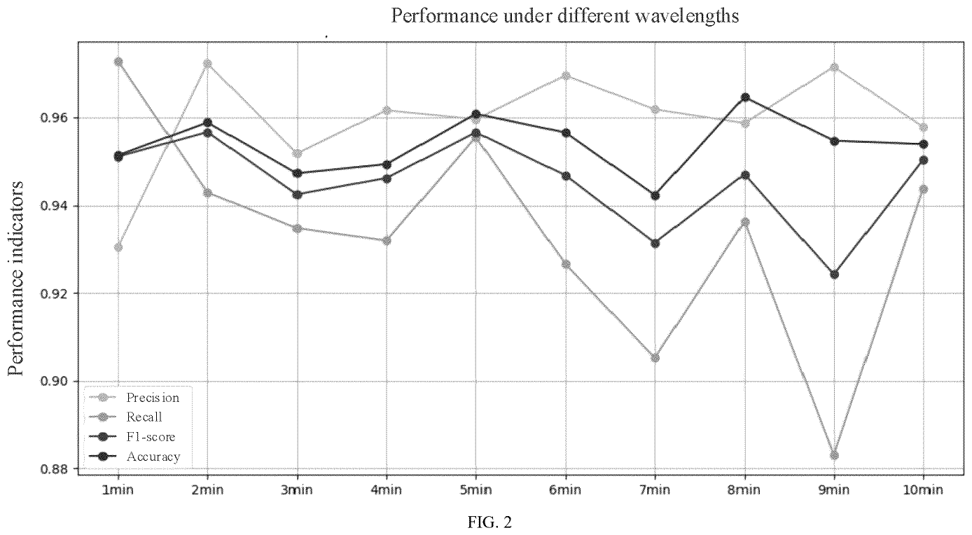

is input into the encoder. The attention mechanism of the present disclosure employs multi-head attention (FIG. 2) to enable the model to capture diverse features and dependencies of input data from different perspectives or subspaces. In the present disclosure, h=1, 2, 3 . . . H denotes the number of heads. Each head transforms its input into query, key, and value matrices, respectively:

$${Q}_{i}^{h} = {( {\tilde{x}}_{i}^{d} )}^{T} {W}_{Q}^{h} , {K}_{i}^{h} = {( {\tilde{x}}_{i}^{d} )}^{T} {W}_{K}^{h} ,$$

$${V}_{i}^{h} = {( {\tilde{x}}_{i}^{d} )}^{T} {W}_{V}^{h} , {W}_{Q}^{h} , {W}_{K}^{h} ∈ {ℝ}^{D \times {d}_{k}} , {W}_{V}^{h} ∈ {ℝ}^{D \times D} .$$

Subsequently, attention

$${A}_{i}^{h} ∈ {ℝ}^{D \times N}$$

is calculated:

$${A}_{i}^{h} = Attention ( {Q}_{i}^{h} , {K}_{i}^{h} , {V}_{i}^{h} ) = Softmax ( \frac{{Q}_{i}^{h} {K}_{i}^{{h}^{T}}}{\sqrt{{d}_{k}}} ) {V}_{i}^{h}$$

Outputs of all heads are concatenated, and the concatenated result is mapped to the required model dimension via a linear layer:

$$MultiHead ( {Q}_{i} , {K}_{i} , {V}_{i} ) = Concat ( {head}_{1} , {head}_{2} … {head}_{H} ) {W}_{O}$$

where headᵢ denotes an output of each head, W_{O}∈ [symbol] ^{D×D}. Finally, the output is passed through a feedforward layer to obtain classification results for each min of the waveform, [symbol] =(y¹, y², . . . , y^{C})∈ [symbol] ^{1×C}, where y^{k}∈(0,1), k=0, 1 . . . C.
S35. A loss function is designed to measure a difference between a predicted probability and a true probability token, and the debris flow-induced ground vibration signal identification result is output.

BCELoss serves as the loss function for the classification problem to measure the difference between predicted probability and true probability token, expressed as:

$$BCE ( y , \hat{y} ) = - \frac{1}{N} {\sum }_{i}^{N} [ {y}_{i} log ( {\hat{y}}_{i} ) + ( 1 - {y}_{i} ) log ( 1 - {\hat{y}}_{i} ) ]$$

where N denotes a sample size; yᵢ denotes a true token of an i-th sample; and ŷᵢ denotes a predicted probability of the i-th sample.

Debris flows involve moving linear sources, differing from earthquakes (point sources). Collisions between particles within the fluid and collisions between particles and the riverbed cause debris flows to continuously radiate surface waves outward while moving through channels. To capture contextual information of varying lengths, identical training samples are adopted for different models in experiments, though sample lengths differ across models. Validation results of the 2017-2019 dataset are shown in FIG. 2.

In FIG. 2, an overall upward trend in F1 score and accuracy is observed during 1-5 min. This indicates that when the waveform is appropriately extended, it provides more contextual information to aid model learning. When the waveform exceeds 5 min, overall performance declines. This suggests that an excessively long waveform firstly causes a substantial increase in model parameters and, due to limited training samples, likely leads to model underfitting. Besides, a larger window may introduce more noise or cause information overload in certain scenarios, thereby reducing model identification precision.

When a short waveform (<3 min) is input, the model exhibits high recall but low precision at 1 min. This indicates the model performs well in identifying debris flow events at this waveform length, but it also misclassifies a considerable number of negative samples (non-debris flow events) as positive. The model shows high precision but low recall at 2 min. This demonstrates the model accurately identifies positive samples but misses a significant portion of positive samples. When the waveform is appropriately extended (3-5 min), the difference in recall and precision exhibits a decreasing trend. However, when the waveform is excessively long (>5 min), this difference gradually widens. This implies the model becomes highly cautious in identifying positive samples at this stage, classifying waveforms as positive only when very certain. Among the tested waveform lengths, the 5-min waveform effectively balances recall (0.955) and precision (0.959), indicating a favorable balance between missed alarm rate and false alarm rate in practical early warning.

These experimental results clearly demonstrate the advantages of the PFT model in multiple aspects for debris flow early warning tasks. Unlike traditional models requiring complex feature engineering, the PFT model directly extracts key features of time series from raw waveforms without human intervention. This endows the model with stronger capability to capture underlying data patterns. Moreover, the PTF model not only adapts to time windows of varying lengths but also maintains relatively stable performance within appropriate time scales (2-5 min), with PTF_5 min performing best.

To more intuitively demonstrate the overall performance of the PTF model and its classification capability for each category, receiver operating characteristic (ROC) curves and confusion matrices are computed. The former serves as a tool for evaluating classification model performance, illustrating the relationship between the model's false positive rate (FPR) and true positive rate (TPR). The latter displays a comparison between the model's predictions and actual results in matrix form to analyze correct and incorrect classifications of the model.

TPR denotes the proportion of positive samples correctly classified, also termed recall or sensitivity. FPR denotes the proportion of incorrectly predicted cases relative to true negatives.

$$TPR = \frac{TP}{TP + FN} , FPR = \frac{FP}{FP + TN}$$

TP denotes the number of correctly predicted positive samples, FN denotes the number of actual positive samples predicted as negative, FP denotes the number of actual negative samples predicted as positive, and TN denotes the number of correctly predicted negative samples.

The confusion matrix reveals that appropriately extending the waveform length below 5 min benefits identification of positive samples (debris flows) (0.93 to >0.95). When the waveform length exceeds 5 min, the capability of the model to identify positive samples declines, but the model becomes more accurate (0.97 to >0.99) in the identification of negative samples. The reason may be that excessively long debris flow waveforms involve altered dynamic processes (such as erosion), causing variations in debris flow signals at earlier and later patches of the debris flow signal, thereby reducing model precision.

Overall, the PFT-based model demonstrates strong robustness in debris flow classification tasks. Particularly the model exhibits high capability at the 5-min wavelength, in identifying both positive and negative samples, effectively reducing risks of missed alarms and false alarms in subsequent early warning tasks.
S4: performing debris flow early warning according to a set alarm threshold based on the debris flow-induced ground vibration signal identification result.

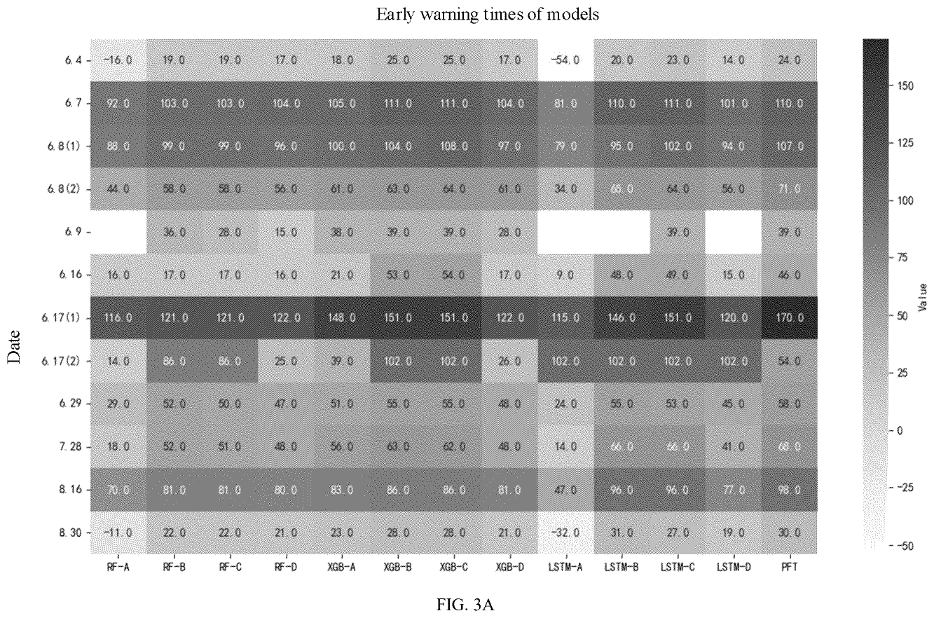

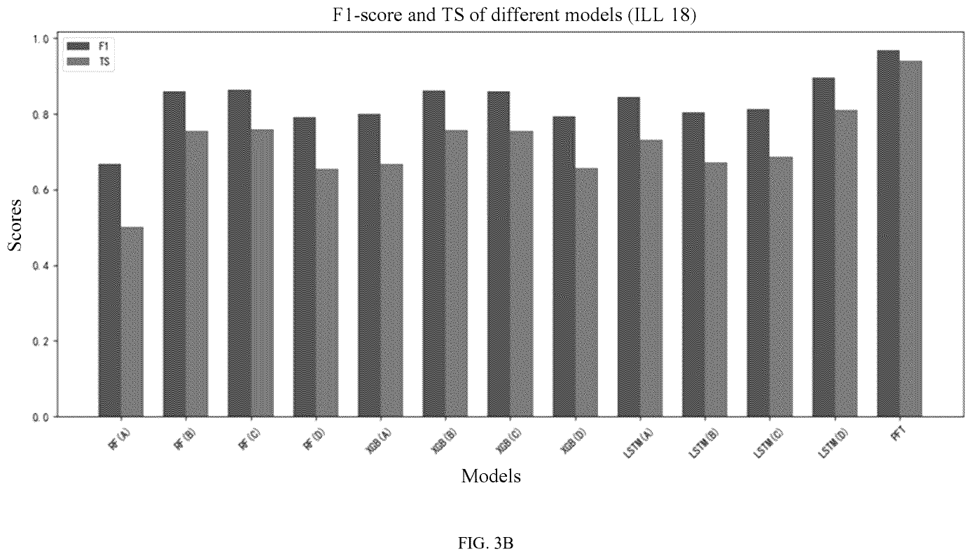

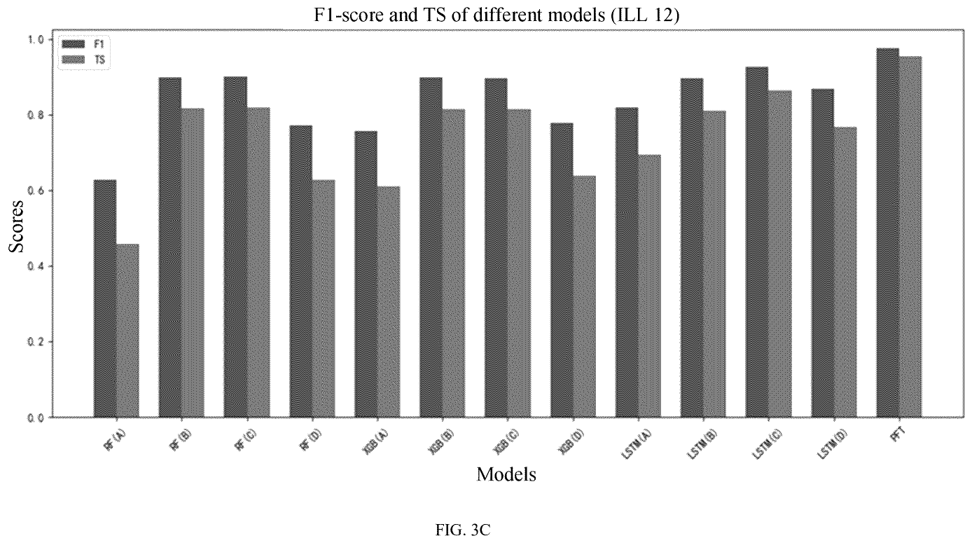

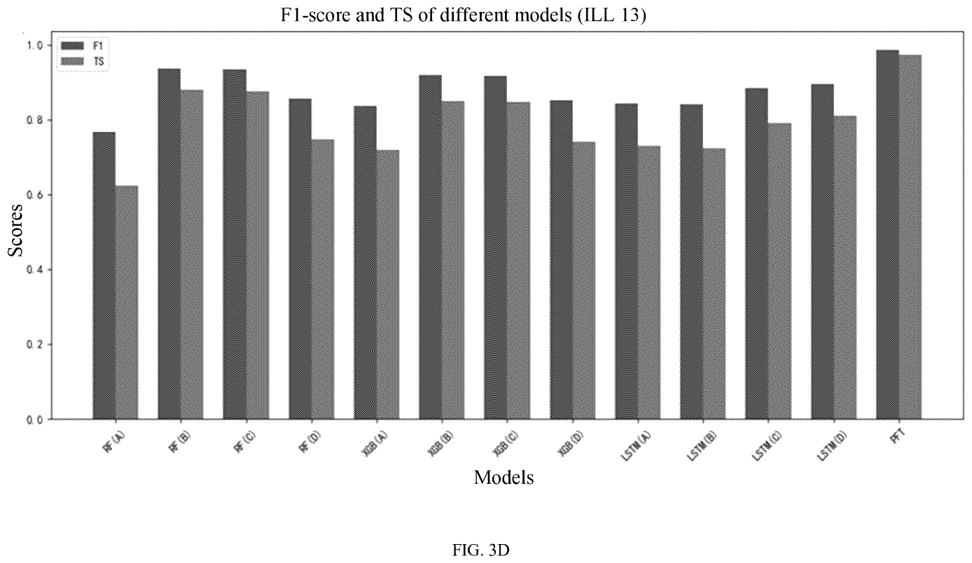

Real-time early warning for debris flows is further implemented based on debris flow signal identification. For the 12 events in 2020, PFT provided early warning times ranging from 24 to 170 min. For 11 events (excluding the event on 2020 Jun. 17 (2)), PFT outperformed RF and LSTM in early warning times, and for 9 events (excluding the events on 2020 Jun. 4, June 8 (1), and June 17), it outperformed XGB, as shown in FIG. 3A.

The model provides no warning times later than debris flow front arrival times (delayed warnings) and exhibits neither missed alarms nor false alarms. For feature-engineered models, while LSTM outperforms tree models (RF, XGB) in case of Feature A, delayed warnings of 54 min and 32 min occur for the 2020 Jun. 4 and 2020 Aug. 30 events, respectively (warning times later than front arrival times). Although RF and XGB show comparable identification performance, delayed warnings also occurred in these two events. In case of Feature B, the early warning performance of the tree models and LSTM is significantly improved, increasing the early warning time by 38.3%. In case of Feature C, XGB and LSTM further extend the early warning times by 0.6% and 5.5% respectively. This indicates Benford's Law is unsuitable for standalone early warning. After feature selection, the early warning times of the three models decrease by 11%, 24.2%, and 22.5%, respectively. This demonstrates that even low-weight features contribute during actual model operation. Additionally, RF-A and LSTM-ABD produce missed alarms during the minor flood event on Jun. 9, 2020. However, the model of the present disclosure accurately identifies such challenging events.

The PFT model can precisely identify even multiple closely spaced debris flow events. For example, for the two events occurring on Jun. 8, 2020, a 95 min interval cause clearly separated predictions across stations, indicating the model detects boundaries between the events. However, for events with shorter intervals, such as the two events occurring on Jun. 17, 2020 (40 min apart), ILL12 maintains consistently high prediction confidence while ILL18 and ILL13 exhibit certain separation phenomena. Through cross-validation between stations, the model of the present disclosure can accurately distinguish between different events.

The alarm threshold has a significantly impact on actual early warning results. When the threshold is low, frequent false alarms may still occur even though the stations can reduce false positives through cross-validation. For example, when the threshold is set to 1, the early warning time can be advanced by approximately ten min compared to the baseline, but the false alarm rate increases significantly. When the threshold is set too high, false alarms can be effectively avoided, but missed alarms tend to occur for minor debris flow events. However, in practical early warning scenarios, tokens of sequential samples in continuous waveform data exhibit significant spatiotemporal correlations, meaning tokens at a given moment and its adjacent moments tend to be highly similar. Thus, inappropriate thresholds can greatly affect the results. Furthermore, when a single station independently performs debris flow early warning tasks, merely increasing the threshold (<15) cannot entirely eliminate false alarms. When the threshold exceeds 10, the missed alarm rate and F1 score of a single station tend to stabilize. Therefore, the alarm threshold for the first station is set to 10 to ensure model stability and reliability. Considering the cross-validation mechanism among stations, the threshold for the remaining stations is set to 5 to further extend the early warning time. Under this configuration, the model can effectively avoid false alarms and ensure that the early warning times are not excessively shortened.

Additionally, the performance of PFT is compared with that of feature-engineered models for evaluation. As shown in FIGS. 3B to 3D, with Benford's Law features (Feature A), the LSTM model performs best: F1=0.8451 and TS=0.7318 for ILL18 station; F1=0.8193 and TS=0.6939 for ILL12 station; and F1=0.8432 and TS=0.7290 for ILL13 station. This indicates that LSTM is more suitable for capturing temporal dependencies. XGB and RF models exhibit comparable performance across stations but slightly underperform LSTM. When Feature B (waveform, spectrum, etc.) is used, tree models (XGB, RF) show significant improvement in performance, especially XGB achieves F1=0.8616 and TS=0.7569 at ILL18 station. However, LSTM's performance declines at ILL18 and ILL13 stations, suggesting possible overfitting. Feature C (hybrid features of A and B) maintains tree models' performance while enhancing LSTM's performance across stations, particularly at ILL12 station (F1=0.9274, TS=0.8646). This indicates that LSTM can better utilize feature complementarity. Finally, Feature D (selected feature) has a negatively impact on the tree models, with reduced F1 and TS for XGB, while improving LSTM's performance at ILL18 (F1=0.8954, TS=0.8106) and ILL13 stations (F1=0.8945, TS=0.8092). This demonstrates feature selection benefits LSTM. PFT exhibits stable performance across different stations. Notably at ILL13 station, FP achieves the optimum performance: 0 (classification results of positive/negative samples for different models are shown in Table 1), and both F1 and TS surpass all models: 0.9864, 0.9732. The performance at ILL12 and ILL18 stations also exceeds feature-engineered models, with higher inter-station stability.

$$F 1 = \frac{2 \times T P}{2 \times TP + FN + FP}$$

measures the balance between precision and recall. High F1 values indicate accurate debris flow identification while effectively avoiding false alarms (false positives) and missed alarms (false negatives). Both aspects are crucial in debris flow early warning contexts.

$$TS = \frac{TP}{TP + FN + FP} ,$$

where a high TS value indicates accurate debris flow sample identification and strong consistency with ground truth.

TABLE 1
Comparison of 2020 waveform identification results between
the PFT model and all feature-engineered models

| Station | Model | TN | FP | FN | TP | F1 | TS |
|---|---|---|---|---|---|---|---|
| ILL18 | RF(A) | 180408 | 110 | 404 | 518 | 0.6684 | 0.5019 |
| | RF(B) | 180496 | 22 | 209 | 713 | 0.8606 | 0.7553 |
| | RF(C) | 180498 | 20 | 206 | 716 | 0.8637 | 0.7601 |
| | RF(D) | 180442 | 76 | 269 | 653 | 0.7910 | 0.6543 |
| | XGB(A) | 180412 | 106 | 235 | 687 | 0.8012 | 0.6683 |
| | XGB(B) | 180420 | 98 | 150 | 772 | 0.8616 | 0.7569 |
| | XGB(C) | 180420 | 98 | 151 | 771 | 0.8610 | 0.7559 |
| | XGB(D) | 180432 | 86 | 259 | 663 | 0.7935 | 0.6577 |
| | LSTM(A) | 180387 | 51 | 210 | 712 | 0.8451 | 0.7318 |
| | LSTM(B) | 180281 | 157 | 196 | 726 | 0.8044 | 0.6728 |
| | LSTM(C) | 180353 | 85 | 231 | 691 | 0.8139 | 0.6862 |
| | LSTM(D) | 180304 | 134 | 66 | 856 | 0.8954 | 0.8106 |
| | PFT | 168186 | 99 | 162 | 4128 | 0.9693 | 0.9405 |
| ILL12 | RF(A) | 179775 | 213 | 689 | 763 | 0.6285 | 0.4583 |
| | RF(B) | 179887 | 101 | 183 | 1269 | 0.8994 | 0.8171 |
| | RF(C) | 179889 | 99 | 183 | 1269 | 0.9000 | 0.8182 |
| | RF(D) | 179823 | 165 | 437 | 1015 | 0.7713 | 0.6277 |
| | XGB(A) | 179745 | 243 | 419 | 1033 | 0.7573 | 0.6094 |
| | XGB(B) | 179846 | 139 | 156 | 1296 | 0.8978 | 0.8146 |
| | XGB(C) | 179849 | 139 | 157 | 1295 | 0.8974 | 0.8140 |
| | XGB(D) | 179793 | 195 | 401 | 1051 | 0.7791 | 0.6381 |
| | LSTM(A) | 179831 | 77 | 391 | 1061 | 0.8193 | 0.6939 |
| | LSTM(B) | 179695 | 213 | 101 | 1351 | 0.8959 | 0.8114 |
| | LSTM(C) | 179765 | 143 | 73 | 1379 | 0.9274 | 0.8646 |
| | LSTM(D) | 179844 | 64 | 288 | 1164 | 0.8687 | 0.7678 |
| | PFT | 168861 | 214 | 118 | 6842 | 0.9763 | 0.9537 |
| ILL13 | RF(A) | 180024 | 130 | 405 | 881 | 0.7671 | 0.6222 |
| | RF(B) | 180141 | 13 | 144 | 1142 | 0.9357 | 0.8791 |
| | RF(C) | 180141 | 13 | 148 | 1138 | 0.9339 | 0.8761 |
| | RF(D) | 180134 | 20 | 310 | 976 | 0.8554 | 0.7473 |
| | XGB(A) | 180092 | 62 | 316 | 970 | 0.8369 | 0.7196 |
| | XGB(B) | 180113 | 41 | 160 | 1126 | 0.9181 | 0.8485 |
| | XGB(C) | 180112 | 42 | 161 | 1125 | 0.9172 | 0.8471 |
| | XGB(D) | 180125 | 29 | 312 | 974 | 0.8510 | 0.7407 |
| | LSTM(A) | 179899 | 175 | 221 | 1065 | 0.8432 | 0.7290 |
| | LSTM(B) | 179754 | 320 | 124 | 1162 | 0.8396 | 0.7235 |
| | LSTM(C) | 179813 | 261 | 63 | 1223 | 0.8830 | 0.7906 |
| | LSTM(D) | 179992 | 82 | 179 | 1107 | 0.8945 | 0.8092 |
| | PFT | 169020 | 0 | 160 | 5825 | 0.9864 | 0.9732 |

The present disclosure is described with reference to the flowcharts and/or block diagrams of the method, the device (system), and the computer program product according to the embodiments of the present disclosure. It should be understood that each flow and/or block in the flowchart and/or block diagram and a combination of the flow and/or block in the flowchart and/or block diagram can be implemented by computer program instructions. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may also be stored in a computer readable memory that can guide a computer or other programmable data processing devices to work in a specific manner, such that the instructions stored in the computer readable memory produce an article of manufacture including an instruction device, and the instruction device implements the functions specified in one or more flows of the flowchart and/or one or more blocks in the block diagram.

These computer program instructions may alternatively be loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In this specification, specific embodiments are used to describe the principle and implementations of the present disclosure, and the description of the embodiments is only intended to help understand the method and core idea of the present disclosure. Meanwhile, those skilled in the art may, based on the idea of the present disclosure, make modifications with respect to the specific implementations and the application scope. Therefore, the content of this specification shall not be construed as a limitation to the present disclosure.

Those of ordinary skill in the art will understand that the embodiments described herein are intended to help readers understand the principles of the present disclosure, and it should be understood that the protection scope of the present disclosure is not limited to such special statements and embodiments. Those of ordinary skill in the art may make other various specific modifications and combinations according to the technical teachings disclosed in the present disclosure without departing from the essence of the present disclosure, and such modifications and combinations still fall within the protection scope of the present disclosure.

1. A machine learning-based debris flow early warning method, comprising the following steps:
S1: acquiring a debris flow-induced ground vibration signal, and constructing a patch attention mechanism-based debris flow-induced ground vibration signal identification model;
S2: extracting a temporal feature of the debris flow-induced ground vibration signal through the patch attention mechanism-based debris flow-induced ground vibration signal identification model, and embedding positional encodings at different positions;
S3: calculating an attention weight through a multi-head attention mechanism, and deriving a debris flow-induced ground vibration signal identification result through a fully connected layer; and
S4: performing debris flow early warning according to a set alarm threshold based on the debris flow-induced ground vibration signal identification result.

2. The machine learning-based debris flow early warning method according to claim 1, wherein the step S2 comprises the following steps:
S21: performing instance normalization on the debris flow-induced ground vibration signal through the patch attention mechanism-based debris flow-induced ground vibration signal identification model;
S22: segmenting the debris flow-induced ground vibration signal through an overlapping sliding window, and performing Fourier transform on each segmented patch to obtain a patch sequence; and
S23: extracting a temporal feature of patches in the patch sequence obtained after Fourier transform through a long short-term memory (LSTM) model, and embedding positional encodings of the patches at corresponding positions.

3. The machine learning-based debris flow early warning method according to claim 2, wherein the step S23 comprises the following steps:
S231: segmenting the patch sequence obtained after Fourier transform into a patch sequence with a reduced dimension through the overlapping sliding window;
S232: allowing each patch in the patch sequence with the reduced dimension to pass through the LSTM model to extract a temporal feature of the corresponding patches, such that an original patch sequence is transformed into new patch sequences with the reduced dimension and an unchanged patch count, and the LSTM model shares weights across all the new patch sequences; and
S233: embedding positional information of the new patch sequences into the patch attention mechanism-based debris flow-induced ground vibration signal identification model through the positional encodings.

4. The machine learning-based debris flow early warning method according to claim 3, wherein in the step S233, the embedding is performed by:
$$P {E}_{( pos , 2 i )} = sin ( \frac{pos}{1 {0000}^{\frac{2 i}{{d}_{model}}}} )$$
$${PE}_{( pos , 2 i + 1 )} = cos ( \frac{pos}{1 {0000}^{\frac{2 i}{{d}_{model}}}} )$$
wherein PE denotes embedding for a dimension corresponding to a current position and a position vector; pos denotes the current position; i denotes a dimension index in the position vector; and d_{model} denotes a dimension of an input vector.

5. The machine learning-based debris flow early warning method according to claim 3, wherein in the step S233, a patch embedded with the positional encoding is expressed as:
$${\tilde{x}}_{i}^{d} = {W}_{P} ( {\tilde{x}}_{i} ) + {W}_{pos}$$
wherein
$${\tilde{x}}_{i}^{d}$$
denotes the patch embedded with the positional encoding; Wₚₒₛ denotes the positional encoding; and \tilde{x}ᵢ denotes a patch in the new patch sequence.

6. The machine learning-based debris flow early warning method according to claim 3, wherein the step S3 comprises the following steps:
S31: taking a patch embedded with the positional encoding as an encoder input;
S32: transforming the encoder input into a query matrix, a key matrix, and a value matrix through the multi-head attention mechanism;
S33: calculating an attention based on the query matrix, the key matrix, and the value matrix;
S34: concatenating outputs of all heads to obtain a concatenated result, and mapping the concatenated result to a set dimension of the patch attention mechanism-based debris flow-induced ground vibration signal identification model through a linear layer; and
S35: designing a loss function to measure a difference between a predicted probability and a true probability token, and outputting the debris flow-induced ground vibration signal identification result.

7. The machine learning-based debris flow early warning method according to claim 6, wherein in the step S32, the query matrix, the key matrix, and the value matrix are respectively expressed as:
$${Q}_{i}^{h} = {( {\tilde{x}}_{i}^{d} )}^{T} {W}_{Q}^{h}$$
$${K}_{i}^{h} = {( {\tilde{x}}_{i}^{d} )}^{T} {W}_{K}^{h}$$
$${V}_{i}^{h} = {( {\tilde{x}}_{i}^{d} )}^{T} {W}_{V}^{h}$$
wherein
$${Q}_{i}^{h} , {K}_{i}^{h} , {V}_{i}^{h}$$
denote the query matrix, the key matrix, and the value matrix of an h-th head, respectively; and
$${W}_{Q}^{h} , {W}_{K}^{h} , {W}_{V}^{h}$$
denote linear transformation matrices of the query matrix, the key matrix, and the value matrix of the h-th head, respectively.

8. The machine learning-based debris flow early warning method according to claim 6, wherein in the step S34, the concatenated result is mapped to the set dimension of the patch attention mechanism-based debris flow-induced ground vibration signal identification model through the linear layer by:
$$MultiHead ( {Q}_{i} , {K}_{i} , {V}_{i} ) = Concat ( {head}_{1} , {head}_{2} … {head}_{H} ) {W}_{O}$$
wherein Qᵢ, Kᵢ, Vᵢ denote the query matrix, the key matrix, and the value matrix, respectively; head_{H} denotes an output of each head, with subscripted H denoting a head index; and W_{O} denotes a weight matrix of the linear layer.

9. The machine learning-based debris flow early warning method according to claim 6, wherein in the step S35, the loss function is expressed as:
$$BCE ( y , \hat{y} ) = - \frac{1}{N} {\sum }_{i}^{N} [ {y}_{i} log ( {\hat{y}}_{i} ) + ( 1 - {y}_{i} ) log ( 1 - {\hat{y}}_{i} ) ]$$
wherein N denotes a sample size; yᵢ denotes a true token of an i-th sample; ŷᵢ denotes a predicted probability of the i-th sample; and BCE denotes a binary cross-entropy loss function.
